(19) United States
(12) Patent Application Publication
(10) Pub. No.: US 2026/0344570 A1
(43) Pub. Date: Nov. 5, 2026

(54) FEEDERHOUSE ASSEMBLY

(71) Applicant: AGCO do Brasil Soluções Agrícolas Ltda., Jundiaí-São Paulo (BR)

(72) Inventor: Marcelo Carpenedo, Jundiaí-São Paulo (BR)

(21) Appl. No.: 19/656,174

(22) Filed: Apr. 23, 2026

(30) Foreign Application Priority Data
Apr. 28, 2025 (GB) 2506419.7

(51) Int. Cl. A01D 61/00

(52) U.S. Cl. CPC A01D 61/008

(57) ABSTRACT

A feederhouse assembly comprises a frame structure having first and second side walls and upper and lower walls defining an inlet at a first end of the frame structure and an outlet at a second end of the frame structure, a feederhouse conveyor located within the frame structure extending between the inlet and the outlet and defining a transportation area between a lower travelling section of the feederhouse conveyor and the lower wall of the frame structure, a material processing area ahead of the outlet adjacent the feederhouse conveyor and a return area between an upper return section of the feederhouse conveyor and the upper wall of the frame structure; and a driven roller located between the transportation area and the return area, having a plurality of vanes, in use, to create an airflow directed toward the second material processing area.

### CROSS-REFERENCE TO RELATED APPLICATION

This application claims the benefit of the filing date of United Kingdom Patent Application 2506419.7, filed Apr. 28, 2025, the entire disclosure of which is incorporated herein by reference.

### FIELD

Embodiments of the present disclosure relate generally to combine harvesters, and the feederhouse assembly used to deliver crop material to the threshing system of the combine harvester, and more particularly to an improvement for the feederhouse assembly.

### BACKGROUND

Backfeeding is a constant issue present during the harvesting process, especially when very dry crops are being processed. This is caused by a combination of factors, among the most important being related to the presence of very dry crops and the fact that the feederhouse has internal parts (the returning chains) that facilitate the backfeeding. Some feederhouse designs are particularly prone to this issue.

Backfeeding occurs when a harvested material, especially dust, returns to a frontal portion of the feederhouse and is released to the environment ahead of a cab of a combine harvester causing an obstruction to operator visibility over the field. This can result in a lower performance of the machine due to the operator restrictions preventing proper control of the harvesting process.

Many known feederhouse designs seek to address this issue. Many current solutions for addressing the backfeeding issue rely upon dust ejectors, which are systems composed of components such as axial fans, drive systems or a channel installed over the feederhouse acting as a suctioning system but all of them working with the basic principle of directly suctioning away the extra dust, in order to avoid the dust being released in front of the combine harvester. These are complex and expensive solutions.

### BRIEF SUMMARY

According to a first aspect of the present invention, a feederhouse assembly comprises a frame structure having first and second side walls and upper and lower walls defining an inlet at a first end of the frame structure and an outlet at a second end of the frame structure, a feederhouse conveyor located within the frame structure extending between the inlet and the outlet and defining a transportation area between a lower travelling section of the feederhouse conveyor and the lower wall of the frame structure, a material processing area ahead of the outlet adjacent the feederhouse conveyor and a return area between an upper return section of the feederhouse conveyor and the upper wall of the frame structure; and a driven roller located between the material processing area and the return area, having a plurality of vanes, in use, to create an airflow directed toward the material processing area.

This has as an advantage that, in use, the airflow together with entrained small detritus such as dust and the like is directed to the second material processing area such that the dust does not follow a path through the third return area toward the feederhouse assembly inlet to be released to the external environment creating operator visibility issues.

Preferably, the driven roller is provided with three vanes.

Preferably, the driven roller is provided at each end with a mounting portion.

Preferably the driven roller is located adjacent the return section of the conveyor above the material processing area.

According to a second aspect, a combine harvester comprises
a crop cutting head;
the feederhouse assembly of the first aspect;
a threshing system;
a separating system; and
a grain cleaning system for receiving the cut and threshed crop material.

Within the scope of this application, it should be understood that the various aspects, embodiments, examples and alternatives set out herein, and individual features thereof may be taken independently or in any possible and compatible combination. Where features are described with reference to a single aspect or embodiment, it should be understood that such features are applicable to all aspects and embodiments unless otherwise stated or where such features are incompatible.

### BRIEF DESCRIPTION OF THE DRAWINGS

The invention will now be described, by way of example only, with reference to the accompanying drawings, in which:

FIG. 1 shows a schematic side view of a known combine harvester;

FIG. 2 shows a first perspective view including a feederhouse assembly for use in the present invention;

FIG. 3 shows a side section of the elements shown in FIG. 2;

FIG. 4 shows a second perspective view of the feederhouse assembly of FIG. 2;

FIG. 5 shows a details of the side section shown in FIG. 3;

FIG. 6 shows a perspective view of a roller for use in the feederhouse assembly of the present invention; and

FIG. 7 shows a sectional view of the roller of FIG. 6.

### DETAILED DESCRIPTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

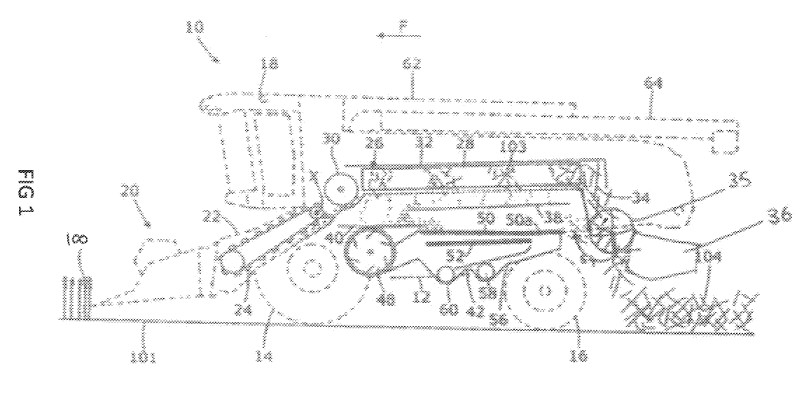

Relative terms such as forward, rearward, transverse, lateral, longitudinal and sideways will be made with reference to the normal forward direction of travel of the combine 10 and indicated by arrow F represented in FIG. 1. The terms vertical, horizontal, above and below will be made with reference to the level ground 101 upon which the combine 10 is disposed. In other words, the Cartesian axes of 'longitudinal', 'transverse', and 'vertical' are made in relation to the chassis 12 of combine 10 and are not affected by any slope in the ground. The terms "upstream" and "downstream" are made with reference to the general direction of crop flow along the material conveyance systems described.

FIG. 1 illustrates in schematic form the main components of the crop processing system of a combine harvester 10 and will be used to explain the flow of material below. The crop processing system is shown in solid lines whilst the outline profile of harvester 10 is shown in ghost form.

Combine harvester 10, hereinafter referred to as 'combine', includes a chassis 12 supported on front wheels 14 and rear steerable wheels 16 which engage the ground 101. A driver's cab 18 is also supported on the chassis 12 and houses a driver's station from where a driver controls the combine 10.

A cutting header 20 is detachably supported on the front of a feederhouse assembly 22 which is pivotable about a transverse axis x to lift and lower the header 20 in a conventional manner.

The combine 10 is driven in a forward direction (arrow F) across a field of standing crop 100 in a known manner. The header 20 serves to cut and gather the standing crop material before conveying such as a crop material stream into the feederhouse assembly 22. An elevator 24, normally in the form of a chain and slat conveyor 110 or elevator as shown, is housed within the feederhouse assembly 22 and serves to convey the crop material stream upwardly and rearwardly from the header 20 to the crop processor designated generally at 26. At this stage the crop material stream is unprocessed.

The crop processor 26 of the illustrated combine 10 includes a pair of axial flow threshing and separating rotors 28 fed by a tangential flow, crop material impelling, feed beater 30. It should be appreciated however that alternative types of crop processor may be used without deviating from the scope of the invention. For example, the crop processor may instead include a conventional tangential flow threshing cylinder with a plurality of straw walkers for separation. Alternatively, a single axial-flow processing rotor may be employed.

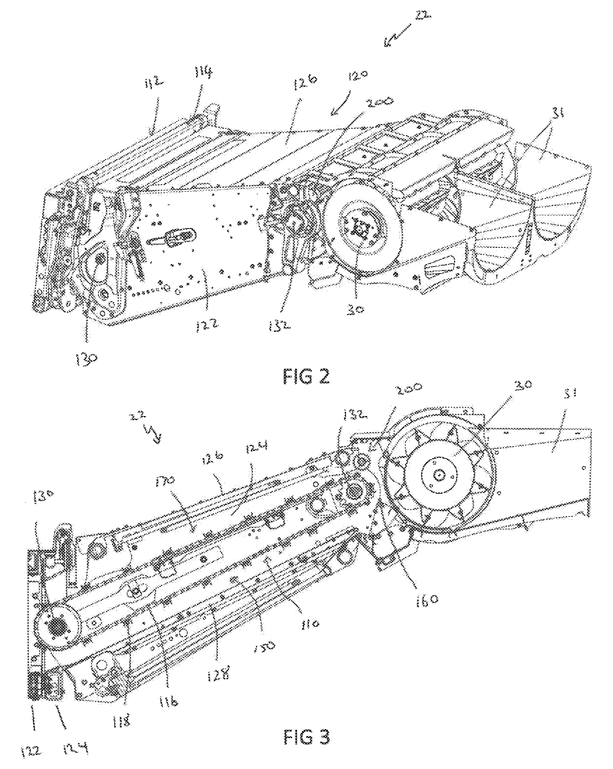

The feed beater 30 rotates on a transverse axis. Crop engaging deflectors 31 (cf FIGS. 2 & 3) which the crop material stream under the beater and into rotor housings 32 (FIG. 1) which each house one of said rotors 28. It should be appreciated that only the left-hand rotor 28 and housing 32 is shown in FIGS. 1 and 3 whereas the right-hand equivalent is hidden from view.

The rotors 28 are positioned to have a generally longitudinal, or fore and aft, rotation axis which is normally inclined upwardly towards the rear of the combine 10.

Flighting elements (not shown) provided on the front end of each rotor 28 engage the crop material stream which is then conveyed as a ribbon or mat 103 in a generally rearward axial and helical path in the space between the rotor 28 and the rotor housing 32.

The axial flow rotors 28 serve to thresh the crop stream in a front region, separate the grain therefrom in a rear region, and eject the straw residue via a straw discharge chute 34 provided below a rear portion of the rotors 28, the straw falling either directly onto the ground in a windrow, or via a straw chopper 35 and straw spreader 36 to be described in more detail later.

A part-cylindrical grate or concave 37 provided in the underside of each rotor housing 32 allows the separated material to fall by gravity onto either a return pan 38 located below a rear section of the processor 26, or directly onto a stratification pan 40 located below a front section of the processor 26. In reality, the separated material falling through the grate 37 is typically a mix of grain and material other than grain (MOG) which may include chaff, tailings and some straw.

The return pan 38 and stratification pan 40 together serve as a material conveyance system arranged to convey the separated crop material to a grain cleaning shoe designated generally at 42. The pans 38,40 each include a respective linkage (not shown) to convert a torque source into oscillating motion to oscillate the pans in a generally fore and aft direction. Combined with a transversely rippled or corrugated floor, the oscillating movement of the return pan 38 and stratification pan 40 propels the material generally forwardly or rearwardly respectively.

The return pan 38 "returns" the separated material incident thereon towards the front of the combine 10 (in the direction F) to a front discharge edge 44 from where the material falls or cascades onto the stratification pan 40. The material on the stratification pan 40 is conveyed rearwardly to a rear discharge edge 46 from where the material falls into the cleaning system or “shoe” 42.

The grain-MOG mix falls from the rear discharge edge 46 into the cleaning shoe 42 where the cascading mix is subjected to a cleaning airstream generated by fan 48, before falling onto the front of upper sieve or chaffer 50.

Chaffer 50 comprises adjustable louvres supported on a frame which is driven in fore-and-aft oscillating manner. The material which settles on the chaffer 50 is conveyed in a generally rearward direction and the heavier smaller grain-rich material passes between the louvres onto an underlying lower sieve 52, whereas the lighter larger material (mostly chaff) passes to the end of the chaffer and out of the rear of the machine at shoe outlet 54. A rear section of chaffer 50a is commonly independently adjustable and is configurable to allow tailings to pass there through into a re-threshing region 56 from where the tailings are conveyed via a re-threshing auger 58 back to the processor 26.

Lower sieve 52 is also driven in an oscillating manner to convey the collected grain-MOG mix rearwardly wherein the material falling there through is collected by a clean grain auger 60 for conveyance to an elevator (not shown) for onward conveyance to a grain tank 62. Material which does not pass through lower sieve 52 and is instead conveyed off the rear edge thereof falls into re-threshing region 56 for subsequent re-threshing.

The airstream generated by fan unit 48 is also conveyed by ducting up through lower sieve 52 and chaffer 50 to encourage lifting of the MOG from the chaffer surface.

For completeness the combine 10 includes an unloading system which includes an unloading auger 64.

Aspects of the invention relate to an improved feederhouse assembly and in particular the provision of a backfeeding roller or rotor as described below.

Referring first to FIGS. 2-4, elements of a feederhouse assembly may be seen.

The feederhouse assembly 22 houses the feederhouse conveyor 110 (FIG. 3) mounted within a frame structure 120.

The frame structure 120 includes first and second side walls 122,124 and upper and lower walls 126,128 defining an inlet at a first front end and an outlet at a second rear end.

The frame structure 120 is provided at the front end with a tilt frame 112 for connection to the header 20. The tilt frame 112 is rotatably adjustable about a longitudinal axis. The longitudinal axis extends in the for-aft direction of the combine. For a horizontal longitudinal axis, the rotation would be in a vertical plane, but the tilt frame 112 may in fact have a backward tilt so that the rotation is in a backward tilted plane.

A pitch frame 114 is mounted at the front end of the frame structure 120 behind the tilt frame 112. The pitch frame 114 is rotatably adjustable about a lateral axis, namely an axis extending horizontally across the lateral width direction of the combine 10. Adjusting the pitch frame tips the top of the cutting head up or down. The pitch frame 114 connects to the front of the frame structure 120.

The rear of the frame structure 120 has a pivotable connection to the chassis of the combine 10 and is located such that the outlet of the frame structure 120 leads to an inlet of the portion of the chassis in which the feed beater 30 of the combine 10 is mounted (FIGS. 2 and 3).

The feederhouse conveyor 110 is located within the frame structure 120 extending between the inlet and the outlet of the frame structure 120. A first, transportation, area 150 is defined between a lower travelling portion of the the feederhouse conveyor 110 and the lower wall 128 of the frame structure 120, a second, material processing, area 160 is located ahead of the inlet adjacent the feederhouse conveyor 110 and a third, return, area 170 is defined between an upper return section of the feederhouse conveyor 110 and the upper wall of the frame structure 120.

The material processing area 160 is located between the feederhouse conveyor 110 and the feed beater 30.

Toward the front of the frame structure 120, where the frame structure 120 couples to the agricultural harvesting head, the feederhouse conveyor 110 comprises a laterally extending front shaft 130 extending through the first and second side walls 122,124 of the frame structure 120. Toward the outlet of the frame structure 120, where the frame structure 120 couples to the combine, the feederhouse conveyor 110 comprises a laterally extending rear shaft 132 extending through the first and second side walls 122,124 of the frame structure 120.

In the illustrated example, the feederhouse conveyor 110 further comprises four endless chains 116 extend around these two shafts 130,132, typically on toothed sprockets 134. Cross bars or slats 118 are provided extending between pairs of the endless chains to transport the crop material within the feederhouse. In an alternative embodiment the chains are replaced by belts.

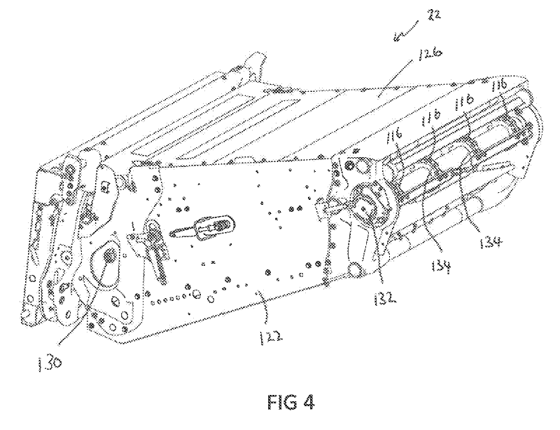

In the illustrated example, a rotating roller 200 is located at the rear of the frame structure 120 (shown most clearly in FIG. 4 in which the feed beater 30 and the crop engaging deflectors 31 have been omitted). As may best be seen from FIG. 3 the rotating roller 200 is located adjacent to a start of the return area 170 of the feederhouse conveyor 110, and above the transportation area 150 within the frame structure 120.

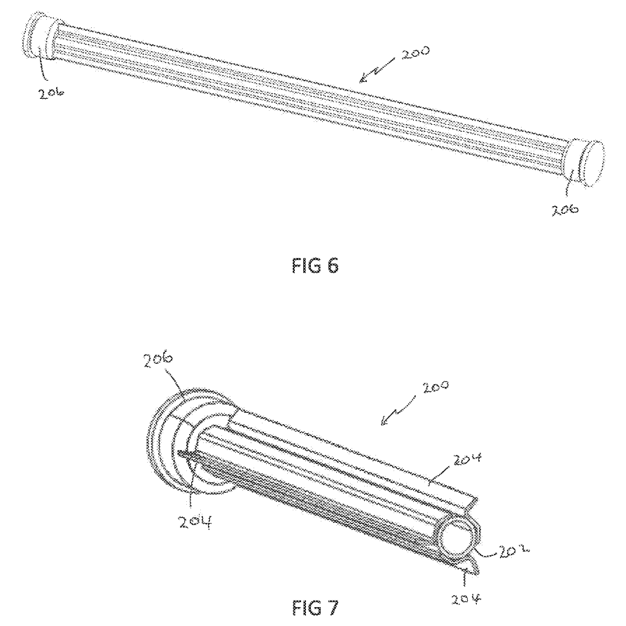

The rotating roller 200 comprises a central driven shaft 202 provided with a number of vanes 204 extending along a length of the shaft between first and second ends of the driven shaft 202. The vanes 204 extend outward from the central driven shaft 202 (FIG. 6 and 7). The vanes 204 may be secured to the driven shaft 202 in any suitable manner. In the illustrated example the rotating roller 200 has three such vanes 204. The driven shaft 202 is provided at each end with a mounting portion 206. The driven shaft 202 may be driven by a suitable motor. Preferably the motor is a hydraulically powered motor, but other forms of motor may be used, including electrical motors. The driven shaft 200 may alternatively be driven by belts or gears conveying drive from elsewhere in the combine harvester.

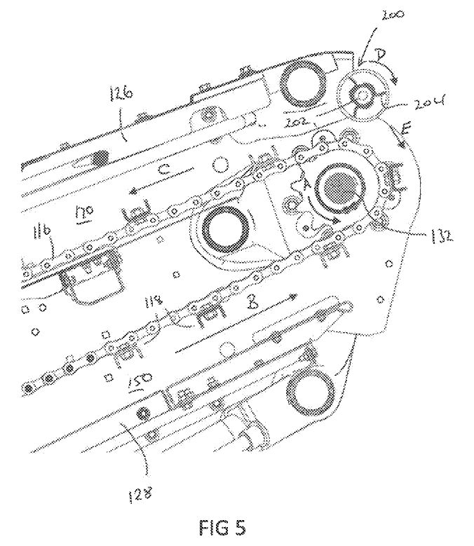

In use, due the rotation (arrow A, FIG. 5) of the driven rear shaft 132 moving the slats 118 carried by the chains 118 (arrow B, FIG. 5) of the feederhouse conveyor 110, the crop material stream is first drawn through the transportation area 150 toward the material processing area 160. The majority of the crop material stream is then directed through the material processing area 160 and toward the feed beater 30 and through the crop engaging deflectors 31 to the separating rotors 28. The remainder of the crop material flow, including lighter materials such as dust, is directed up toward the return area 170 (arrow C). However, due to the rotation (arrow D) of the rotating roller 200, an airflow (arrow E) is generated by the rotating vanes 204 to blow dust and similar lightweight detritus from the remainder of the crop material flow back to the material processing area 160. As may be seen, the rotating roller 200 is driven in a direction (arrow B in FIG. 5) counter to the direction of the upper conveyor shaft 132 (arrow A in FIG. 5).

In this way, the generated airflow, together with entrained small detritus such as dust and the like, is directed back to the material processing area such that the dust does not follow a path through the return area toward the feederhouse assembly inlet to be released to the external environment creating operator visibility issues.

All references cited herein are incorporated herein in their entireties. If there is a conflict between definitions herein and in an incorporated reference, the definition herein shall control.

From reading the present disclosure, other modifications will be apparent to persons skilled in the art. Such modifications may involve other features which are already known in the field of combine harvesters and component parts therefore and which may be used instead of or in addition to features already described herein.

What is claimed is:

1. A feederhouse assembly comprising
a frame structure having first and second side walls and upper and lower walls defining an inlet at a first end of the frame structure and an outlet at a second end of the frame structure,
a feederhouse conveyor located within the frame structure extending between the inlet and the outlet and defining a transportation area between a lower travelling section of the feederhouse conveyor and the lower wall of the frame structure, a material processing area ahead of the outlet adjacent the feederhouse conveyor and a return area between an upper return section of the feederhouse conveyor and the upper wall of the frame structure; and
a driven roller located between the transportation area and the return area, having a plurality of vanes, in use, to create an airflow directed toward the material processing area.

2. A feederhouse assembly according to claim 1, characterised in that the driven roller is provided with three vanes.

3. A feederhouse assembly according to claim 1, characterised in that the driven roller is provided at each end with a mounting portion.

4. A feederhouse assembly according to claim 1, characterised in that the driven roller is located adjacent the return section of the conveyor above the material processing area.

5. A combine harvester comprising
a crop cutting head;
the feederhouse assembly according to claim 1;
a threshing system;
a separating system; and
a grain cleaning system for receiving the cut and threshed crop material.
